(19) United States
(12) Patent Application Publication
(10) Pub. No.: US 2004/0181476 A1
(43) Pub. Date: Sep. 16, 2004

(54) Dynamic network resource brokering

(76) Inventors: William R. Smith, Lyndeborough, NH (US); Nicole D. Gallant-Talavia, Arlington, MA (US); David M. McSweeney, North Reading, MA (US)

Correspondence Address: ROPES & GRAY LLP, ONE INTERNATIONAL PLACE, BOSTON, MA, 02110-2624, US

(21) Appl. No.: 10/389,141

(22) Filed: Mar. 13, 2003

(51) Int. Cl. G06F 17/60

(52) U.S. Cl. 705/35

(57) ABSTRACT

A method and system for identifying and mapping the business-driven IT policies to network resources and automatically brokering resources accordingly is disclosed. A software-based client/server architecture may be used, in an exemplary embodiment, to provision network server, processor, and storage resources according to the policies, service level objectives, and/or service level agreements needed to meet IT infrastructure customer needs with appropriately differentiated service.

### BACKGROUND OF THE INVENTION

1. Field of the Invention

The present invention relates to network resource provisioning, specifically to dynamic resource management and automated systems for resource brokering.

2. Description of the Related Art

The proliferation of complex information technology (IT) infrastructures comprising servers, firewalls, load balancing devices, and related processor resources, as well as storage pools or storage networks and storage management resources, has resulted in systems of increasing cost and complexity. Furthermore, the plethora of management and control interfaces for each of these devices and resources has greatly added to the complexity of managing these systems. The multi-vendor approach commonly seen in the IT field has resulted in very high acquisition and management costs as well as a high total cost of ownership (TCO). In part, this is driven by the need for surge capability in resources, i.e., the requirement to have sufficient resources on standby to handle the highest peak loads. This requirement, coupled with the need to maintain high availability in the face of random failures, has led to the deployment of highly redundant and often over-specified IT resources.

Another complexity seen in IT today is the requirement to provide different levels of service to different users of an IT system. For example, the finance department of a corporation may require rapid access to databases or queries on financial information, while the desktop users in the engineering department of the same corporation may require lower priority, shared access to word processing documents. At the same time, the engineering department may require high priority, high bandwidth access to engineering tools and CAD data files. One common approach is to define use policies or service level agreements (SLA)/service level objectives (SLO) that specify the desired availability and permitted access to networked IT resources in response to varying demands. In such a policy based SLA/SLO system, different availability rules and bandwidth allocations are made a priori by network managers, typically in consultation with user groups. Thus, for example, engineering department users of engineering tools will be allowed more bandwidth and more storage than users of word processing data files from the same department. Likewise, finance department queries and finance department storage resources will be given a higher priority than word processing users in the above example.

While policy-based management techniques have their place, they are generally not sufficiently responsive to rapid changes in network loading or conditions. This is so because currently known policy-based systems generally are put into place at IT network configuration time and updated or changed manually, and only on an infrequent basis. This can result in unacceptable network performance bottlenecks when faced with rapidly (e.g., hourly) varying and competing demands for network resources.

Another shortfall seen in current systems is the low return on investment (ROI) and high TCO resulting from the need for backup and surge-supporting standby resources. Costs are driven up by inefficient management schemes that require dedicated standby and/or backup resources for particular components in the IT system. Such a scenario typically arises because of interoperability problems and incompatibility between management and control interfaces for the various resources.

What is needed is an integrated and autonomous management tool that can dynamically allocate IT resources, such as servers, load balancers, and storage resources in response to changing network conditions and user policy rules. Such a system must reduce the total cost of ownership and increase the return on investment in IT resources while minimizing the expensive and inefficient over-provisioning of standby resources.

### SUMMARY

Presently described is a general framework for mapping a company or IT group's business functions and network architecture to a software-based management system that monitors and interprets network performance data and acts on that data in accordance with pre-defined business priorities. This system begins by identifying the various user groups or constituencies that compete on daily basis for resources. It facilities the development of quality of service (QoS) or differentiated service policies that support or further pre-defined service level agreements amongst the user groups and/or overall service level objectives for the enterprise.

Each of the various network elements and software applications operating on a network typically utilize multiple software processes and multiple processing platforms. Indeed, a variety of different software and hardware suppliers are often called on to provide the various processing and storage resources and their management functions, thus creating interoperability issues and compatibility problems.

The system described herein overcomes this compatibility problem by providing a data access layer that translates the command and interface requirements of various resources into a common “language” usable by the system. The common language is used to both sense network status/loading and to predict future status. Using these predictions, the system adapts the network configuration to conform to pre-defined policies.

Thus, the system allows fast and efficient resource selection and configuration based on pre-defined user rules and policies that enforce differentiated levels of service. The physical resources for implementing this resource brokering and control of IT resources within the dynamic network environment are fully selectable and allocatable by the operators, i.e., the system managers. The managers set the policies for allocating and de-allocating resources by specifying when, in terms of network conditions, additional resources need to be added or removed from the network. Fast resource allocation, such that differentiated network environments can be created from the physical or logical resources within short periods of time and in response to user needs thus results. Fast resource allocation allows for the optimal use of system resources so that the network can be efficiently utilized by more users more of the time, thus enhancing ROI and reducing TCO.

One embodiment of the present invention includes software for a client application capable of remotely configuring a Policy Enforcement Engine and controlling a device discovery component. The Policy Enforcement Engine and device discovery component together model resources in the IT network and configure the interconnections between and allocations of those resources to conform to the business priorities as expressed by the service policies. The operator may express these business policies in the terminology of user solutions and their controls, thereby allowing for greater flexibility in configuring and operating the network.

### BRIEF DESCRIPTION OF THE DRAWINGS

The present disclosure may be better understood and its numerous features and advantages made apparent to those skilled in the art by referencing the accompanying drawings.

FIG. 1 is a high level block diagram of a system adapted to provide resource management, according to one embodiment of the invention.

FIG. 2 is a flow chart of the process, according to one embodiment of the invention.

FIG. 3 is a high level block diagram of the module functionality of one embodiment of the present invention.

FIG. 4 is a flow chart of the rule definition and distribution process, according to one embodiment of the invention.

The use of the same reference symbols in different drawings indicates similar or identical items.

### DETAILED DESCRIPTION

System Overview

Presently disclosed, and referred to herein as the DynamicIT system, is a policy-based resource brokering application that helps data centers and departments within organizations create and enforce differentiated levels of service within and utilizing their existing IT infrastructure. This system works with existing network management and/or control interfaces, including various types of network management software (NMS) systems, and existing hardware in the infrastructure. By providing a consistent, policy-based resource provisioning system, the system can increase resource utilization efficiency and provide enhanced compliance with Service Level Agreements and/or Service Level Objectives (SLAs/SLOs).

In particular, the present system allows infrastructure managers to define differentiated levels of services to the customers or users of the infrastructure. This approach helps to ensure that mission critical applications obtain the necessary resources as efficiently as possible. Infrastructure managers provide differentiated level of service by defining business priority-based policies that the resource brokering application is to apply in making automated provisioning and allocation decisions.

The present system may be implemented, in one embodiment, as a pair of software applications, namely a client and a server application. These applications may be, in some embodiments, implemented in the Java programming language. However, one of ordinary skill in the art will also realize that other programming languages are equally usable for implementing the functionality of the present invention. Accordingly, the invention is not limited to implementations in any single programming language nor is it limited to a strictly client-server architecture.

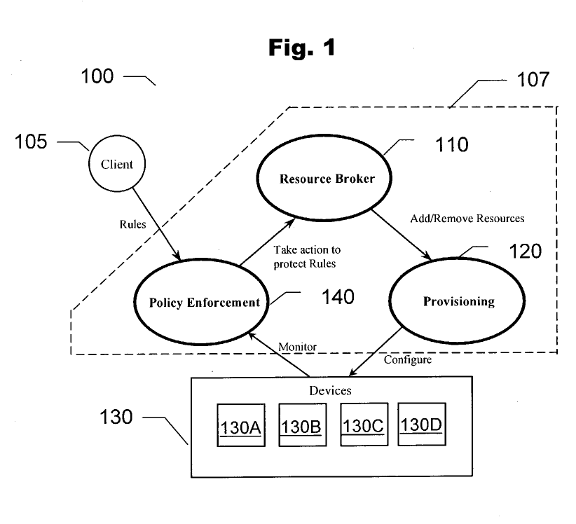

FIG. 1 illustrates a high-level functional block diagram of the resource brokering system. The system 100 consists of client 105, server application 107 (denoted by dashed box), and a pool of network resources 130 that is provisioned and configured according to the present invention. Resource or device pool 130 is in turn comprised of one or more typical resources or devices 130A, 130B, 130C, etc. Devices 130A, 130B, 130C, etc. may consist of servers, load balancers, firewalls, network attached storage (NAS) controllers, storage area networks (SAN), network management systems and/or associated processors and memory systems commonly known and used in the networking art today.

In one embodiment, the system may support Hewlett-Packard's OpenView network node manager NMS for Windows 2000 or Solaris. Although the following description is given in the context of the HP OpenView system, the invention is usable with any network management software system known in the art today. Accordingly, one of ordinary skill will realize that the present invention is usable with a variety of management and/or control interfaces and is not limited to any particular management and/or control interface or NMS.

Server software 107 is comprised of three main functional blocks. Block 140 supplies the policy enforcement function as well as the policy/rule definition interface to client software 105. Policy enforcement block 140 evaluates the conditions of the monitored devices 130 and takes action to implement or protect the rules derived from the pre-defined business policies. The actions taken by policy enforcement 140 are done by way of messages or commands to resource broker 110, which is the function that actively determines which resources to allocate or deallocate in the infrastructure in response to the commanded actions. In adding or removing resources (allocating or de-allocating), resource broker 110 communicates with provisioning function 120. Provisioning function 120 in turn provides command translation and configuration control (via one or more management or control interfaces on each resource) to interface with devices 130.

Client Overview

In some embodiments, client 105 (referring to FIG. 1) is a Java-based, rich client implementing a graphical user interface (GUI) that supports the feature set of the present invention. In particular, the GUI enables the infrastructure managers to define differentiated levels of service, actively manage the provisioning operations (including the set-up of global and/or customer-free pools), and define business policies in detail. The GUI may also implement user-specific, on-screen and/or email notification and can override rules relating to automatic provisioning, thus enabling real time control of the network.

The GUI may also provides the capability, in some embodiments, to display a graphic depicting the network topology; to view log files of provisioning events, user activity, and runtime errors; and to view the status of the devices or resources in the infrastructure.

Server Overview

The server application may also be a Java-based software package implemented on a server computer remote from the client application discussed above. Alternatively, the client application and the server application may run on the same host computer. The functional distinctions between the client and server applications are purely one of logical convenience and are not necessary to the operation of the invention. Indeed, in some embodiments, the two applications may run on a single host or may run on hosts separated by one or more communications links in a local area or wide area network.

The server function is responsible for all direct communications and interfacing with the management or control interfaces (and other software packages) and all target devices and resources in the network infrastructure that participate in provisioning. As is known in the art, various network elements and systems can be obtained from a multitude of vendors. Typically these units have incompatible or at least distinctly different interfaces and operating modes. The server, according to one embodiment, may be architected so that it contains interface translation modules that enable communication and protocol translation between the server and the management or control interface (MCI) and/or the devices to be provisioned. This translation function is described in further detail below.

For ease of deployment and flexibility, the various functional components of the server may be distributed across multiple physical devices or host computers, in keeping with the well-known paradigm of distributed computing and distributed architectures. While a distributed architecture is described, those of ordinary skill in the art will also recognize that all functions can just as easily be implemented on a single host or split between logical threads on the same host or a different hosts. Accordingly, the present invention is not limited in the mode of implementation of the server functions.

The server application functionality (or, more simply, “the server”) provides the following high-level functions. Initially, the server must be able to import and discover network topology and status information from the various network management systems present in the infrastructure or network. This process is referred to here as Value Added Discovery (VAD). It must further use this information to collect additional device characteristics that are pertinent to or necessary for precise provisioning. In some embodiments, this additional information may be collected directly from the managed devices or resources via their individual, native access methods (i.e., through direct commands to those units). The server function is also responsible for resource brokering, defined herein as the process of coordinating and determining the best available resources for provisioning based upon the desired differentiated level of service defined by policy and rule.

One of the major functions of the server is policy enforcement. The server is responsible for collecting performance information from the resources participating in provisioning (i.e., the devices and systems provisioned or controlled by the server). The server is also responsible for determining when additional and/or fewer resources are required. These decisions are made both in real time or near-real time, using information determined from the value-added discovery process discussed above and on predictions of the need for resources made using historical performance information.

Finally, the server actively coordinates all of the process steps required to add or remove resources and resource allocations from the network infrastructure.

The server functionality is also responsible for storing all of the client's configuration information, records of provisioning activity, and the historical performance indicators used as inputs for prediction. As is well known in the art, this information may be stored in log files in the client, the server or in support systems connected thereto.

Inter-component Communication

All of the communications between the client and server applications may be achieved using messages in any of the interprocess messaging formats well known in the art, such as (but not limited to) the eXtensible Markup Language (XML). Additionally, components of the system may also communicate using the industry standard Java messaging service (JMS). As is known to one of ordinary skill, JMS is a Java application programming interface (API) that specifies and enables asynchronous messaging between software components. An implementation of JMS can be thought of as email for applications; JMS decouples the clients from the servers and provides store and forward functionality and message event notification.

Operation

The following high-level concepts and terminology have attached to them a specific meaning in the context of the present disclosure:

Initialization. Initialization involves importing broad device information from third party management or control interfaces on each resource and converting that raw device information into logical identifiers of unallocated resources, via the value added discovery process discussed above.

Configuration. Configuration involves mapping the user infrastructure, i.e., the IT network, as well as routes and paths between networked components and the resource pool to the data structures and functional organization of the DynamicIT system. In particular, configuration involves moving the unallocated resources (through their pointers or other logical reference structures) into a customer-solution-tier-free pool hierarchy. Configuration is not to be confused with provisioning.

Provisioning and De-provisioning. These concepts involve manually or automatically moving resources from free pools into an allocated state (i.e., under the active control of their respective controllers/MCIs) and back. Examples of controllers defined in this context are the virtual servers implemented on load balancers and SAN file systems on servers. The resources that are moved are both servers and logical unit numbers (LUNs). In this context, file systems are made up of LUNs and are always attached to servers. Servers are often attached to load balancers but not always.

Policy. A Policy is the set of rules by which the system automatically provisions and de-provisions resources in a network.

Differentiated Service Levels. Differentiated Service Levels are the results achieved by applying policies in an orderly fashion.

Configuration State. The configuration state is the condition of a resource or of a customer whose resources are being configured, as by the manual actions of provisioning or de-provisioning or the automatic actions under the policy enforcement and resource brokering functions of the present invention. This is to be contrasted to the running state.

Running State. The running state is the condition of resources in the network under which policy enforcement process is continuing in an automatic fashion.

Policy enforcement is the function responsible for interpreting the desired service levels and corresponding policies that were configured by the system operator or manager through the client application. As described above, the system manager does not operate in a vacuum; rather, he or she determines high level business priorities based on the needs of the various user groups served by the IT operation or data center. The concept of policy enforcement therefore involves several interrelated concepts; first and foremost of these is the notion of tiering.

The term tiering is used herein to generally refer to the conceptual division of resources and user sets. One must be very careful here to distinguish between “managers” and “users.” In the context of this disclosure, “managers” are the IT or network system managers or operators that initially configure and control the resource brokering system. The users are the people and groups that use the resources so allocated.

Indeed, the concept of users includes several interrelated groupings. At the highest level are the “customers” which are groups of users that have a particular function within a business organization. This is best explained by example: when the resource brokering system is utilized to manage the IT resources of a large company, the “customers” are typically the different divisions or business entities within the company, such as the accounting department or the engineering department. Clearly, finer divisions and more precise definitions of user groups that have requirements distinct from one another, thereby defining additional “customers,” are possible as well. The distinguishing feature of “customers” is that all users within a customer group have applied to them certain policies, although not necessarily all policies, in a uniform manner.

Within each customer group there are also certain “solution” groups. The term solution, used in this fashion, refers to a particular software application or set of applications that are used by some members of a customer group, although not necessarily all members or not necessarily all members at the same time. An example of a solution is a computer aided design (CAD) application used by members of the engineering department or, by way of further example, an ASIC design group within the engineering department. Generally speaking, each customer has one or more solution or solutions that are deployed to service that customer within the overall IT infrastructure.

Another way to conceptualize the various customers and their solutions is to look at them in terms of “tiers.” The concept of a tiered or N-tiered architecture is well known in the networking arts. For example, one commonly refers to a “web tier” comprising the presentation and application layers (or aspects) of a business solution. The next tier or layer is often referred to as a business logic tier, which typically consists of a hierarchy of applications and includes the application logic which makes decisions based on information from a lower level and passes that information to the upper level (i.e., the web tier). In a third or lower level, one commonly encounters a data base tier, namely a set of data storage solutions or applications and the data therein that is used to operate the business application. Such a three-tiered architecture is typically a model of a how a solution is implemented. In other words, a particular solution used by a customer (in the context of the present disclosure) may consist of multiple logical tiers of functionality.

Operation of the resource brokering system proceeds as follows. Conceptually, the operation begins by examining the specific devices or resources present in each tier that has defined for it a particular service level objective. As the term is commonly used in the art, service level objective (SLO) refers to agreed-upon metrics of performance and availability for a particular service, in this case the service required to fulfill the functions of the defined tier (or even the entire tier itself). Note that general brokering, policy enforcement, and provisioning operations may begin at any particular point in the cycle of brokering, provisioning, and enforcement; however, for clarity, it makes sense to explain the system from the standpoint of the steps that a manager operating the client software would go through in order to initialize the system and transition into its running (policy enforcement) state. Accordingly, the first generalized step is for the operator/manager to define and understand the various customer, solution, and tier policies that need to be enforced.

Thus, the process first begins by examining (or establishing) service level objectives and, if necessary service level agreements (SLAs) between the various customer groups and solution groups and the IT department. This may be accomplished through typical face-to-face (human) negotiation means well known in the art. The operator must then evaluate and understand how the SLOs/SLAs relate to the solutions themselves. This typically involves, for complex solutions, decomposition of the solutions into tiers, as discussed above. The final step in this initial set up process is to collect all of the necessary SLOs/SLAs for entry into the system.

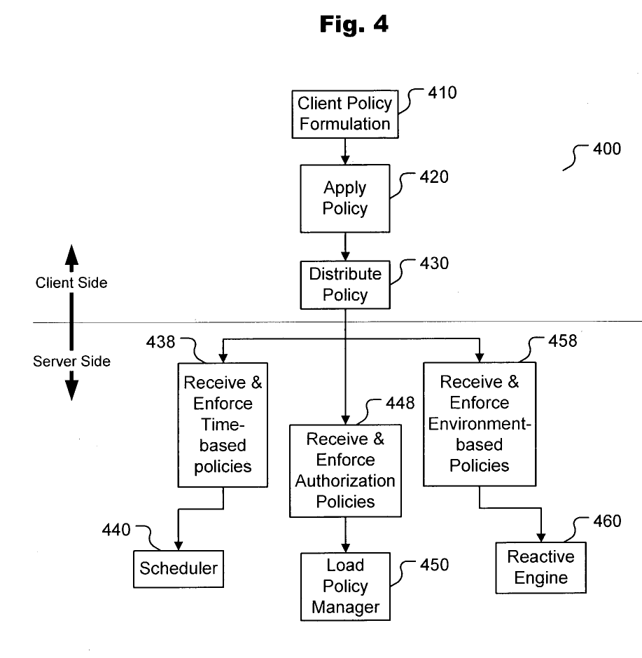

Once the manager has entered the various policies with the client GUI, the client software decomposes and combines the various policies into a set of rules in a format usable by the policy enforcement engine. FIG. 4 illustrates a flowchart of the process whereby rules de-confliction is carried out. In some embodiments, the global policy manager enforces the rule de-confliction through the service levels defined for each customer and the local policy manager states (policies) determined by the system manager for each resource controlled by the local policy manager.

Policies are first formulated by the system manager in step 410, using the client. This effort comprises the following:

Select policy level (i.e., Gold, Silver, Bronze);

Select policy thresholds for server provisioning and de-provisioning (e.g., thresholds for CPU, memory, and/or network usage) and select health action (e.g., sever down=provision);

Select policy thresholds for storage provisioning (e.g., percent of existing storage or a fixed size in megabytes);

Select policy for notification (e.g., when and to whom to send e-mail);

Select policy for confirmation (e.g., ask if auto provisioning action should occur); and

Select if predictive provisioning is to be used and the confidence level for predictions.

Next, step 420, the policy is applied to a customer, solution, or tier by enabling that policy on the customer, solution, or tier. The server is then released to distribute the policy in step 430.

In step 430, the global policy manager (GPM) begins enforcement of notification and confirmation policies and distributes time-based policies, as further discussed below. Obligation policy levels and thresholds are also sent to the reactive engine and the aggregation modules. Finally, the GPM starts policy level selection logic for incoming provisioning messages.

In particular, time-based policies are received and acted on 438 by the scheduler in step 440. Authorization policies are received and acted on 448 by the local policy manager in step 450, which evaluates policy state in each of its resources. Environment-based policies are received and acted on 458 by the reactive engine in step 460, using load data concerning the network/system environment, e.g., memory, CPU, network, and storage loading/utilization data.

The policy enforcement engine is responsible for interpreting the rules that implement the various policies and SLOs/SLAs defined by the system manager. This interpretation involves several concepts. First, the devices in a particular tier that is covered by the defined service level need to be monitored to understand their status. Next, the conditions or predicates set forth in the policy rules must be evaluated based on the information returned from the monitored devices. This may involve several calculations primarily (although not exclusively) to determine utilization percentages, for example. At this time, in some embodiments, prediction calculations may be made on expected future utilization and status of the monitored devices. (The predictive mode necessarily requires device history).

If any of the conditions set forth in the policy rules are met, then the resource broker is contacted (or triggered), through well-known inter-process communication means such as XML or JMS, to take action. When the resource broker receives a request, such as one to add a resource to a particular tier, it uses that request to search for the best available resource to meet the needs of that request. This form of brokering involves looking through the free pools available to that particular customer and or that solution for the best resources matching the needs of the applicable policy or SLO/SLA. No resource will be selected if its characteristics are less than the resources in the base configuration and less then any resources that have been manually provisioned to that tier. This insures that the resource allocation process will not degrade service available in a particular tier.

In particular, when choosing servers connected to a SAN, the system may also ensure that the chosen server can be mapped to the particular SAN used by other servers in the tier. Again, this ensures that SAN interoperability is maintained in the brokering/allocation phase. As a safety feature, the system may also have a built-in notification scheme to alert managers when the free pools are empty. This notification service may consist of alarms or other visual or auditory displays on the client computer display, or email or pager messages available through means well-known in the art. Furthermore, the system may be configured so that it never removes provisioned resources from one customer's configuration in order to satisfy a resource request for another customer. In some embodiments, however, this safety feature may be disabled in order to satisfy a larger group of clients rather than attempting to satisfy each client individually.

Once the best fit resource is identified by the brokering component, the broker hands off an identifier for that resource to the provisioning component. The functions of the provisioning component are further described below.

If the resource broker receives a request to remove a resource, for example when the monitoring function detects that the utilization rate of a particular resource is below a threshold, the resource broker will chose the specific resource to be removed. This may be accomplished by having the resource broker look at the collection of resources in the customer's tier and checking to see which resources have been specified as removable. In other words, the customer may specify that a certain baseline number and type of resources may never be removed from its system, in order to provide a guaranteed base level of service.

Once the provisioning component has been instructed to remove a chosen resource and it has determined that that resource is removable, it will return that resource to the specific free pool that it came from. Alternatively, the resource may go into the customer's free pool, which is the state that all customer-specific resources find themselves before they are assigned to a particular tier.

The provisioning component takes all of the steps necessary and required to add or remove the designated resource to or from the customer's solution or tier. This involves sending configuration commands to the devices. It is in this step that the interprocess messages that identify particular resources to be added or removed are converted into the specific commands and/or translated to comply with the specific APIs needed to interface with the resources themselves and/or their controllers or MCIs.

The prediction feature of the present invention merits additional discussion. Prediction is accomplished by dynamically measuring the time it takes to provision and de-provision each resource to each tier. This historical information, maintained in a data structure available to the server function, is passed on to the prediction component to ensure that timely predictions are made. For example, if (historically) it takes twenty minutes to provision a server to a particular load balancer one needs to ensure that the predictor takes that time into account when making provisioning recommendations. In one embodiment, the “prediction window” (or the amount of time into the future that predictions are made) may be 1.5 times the time to provision a server, rounded up to the next sample time, where the sample time is typically in increments of 15 minutes. Thus, if the time to provision is twenty minutes (i.e., the twenty minutes it takes to provision a server to a particular load balancer, discussed above), the system will predict the need for such provisioning thirty minutes ahead. If, on the other hand the time to provision a particular component is only one minute, the system will predict that provisioning event fifteen minutes ahead. These predicted provisioning events then result in the near real-time triggering of the provisioning function, such that the newly provisioned resource is available and on-line at the time it is expected to be needed, rather than one or twenty minutes thereafter (in the examples above).

One of ordinary skill in the art will recognize that a certain amount of variability in time to provision is to be expected for different resources. In part, this variability is dependant upon the amount of time it takes to execute user-defined provisioning scripts for different pieces of hardware. It is also defined (to a certain extent), by the complexity of provisioning a resource. For example, in order to bring up a new load balancer, a certain amount of configuration file information must be downloaded to the load balancer once it is powered up and available on the network. The amount of time it takes to download this information depends on the size of the files. By contrast, the amount of time it takes to provision a storage system is at least in part determined by the file system that needs to be installed on the storage system, as well as the back-up data that needs to be loaded into the storage elements. Clearly, for a very large file system and data set, the latter period can extend from minutes to hours.

Provisioning Servers

Server provisioning is a special case in the general provisioning scenario. In order to provision a server for use in the network infrastructure, one must first configure the server. During the preparatory phase of server provisioning, i.e., before the server is added to a load balancer or made generally available on the network, the file system must be installed on the server and the user content and settings must be applied to the server and/or file system. (Remember, in this context “user” refers to the member of the customer group that is intended to utilize the system for business purposes.) In one embodiment, both server and storage provisioning may be initiated through common scripted functionality. These scripts, as typically used in the art, perform initial set-up of the resource as well as copying desired user content to the servers and or storage systems. In some embodiments, the server function logs into the physical or logical server to be provisioned through industry standard remote access means (such as Telnet) and downloads a server script. The server function then commands the server being provisioned to execute the script locally. That script reaches out to other network resources, such as backup servers and/or other data storage devices, to obtain the configuration parameters and user content that it needs. This reaching out process may look to the server function or to any other server or device on the network.

Server provisioning itself generally proceeds in a series of logical steps. First, if a specific server is not specified in the provisioning command, the resource broker looks at the characteristics of servers required by the tier at issue to determine the minimum server requirements. The resource broker then searches both the customer free pool (i.e., the pool of free resources defined and uniquely allocated to that by customer) or the global free pool (i.e., a pool of globally available resources available to any customer in the network) to find a server that meets the tier's minimum requirements. In some embodiments, the policy may specify particular free pools to search and/or the order in which to search a list of free pools.

Next, the resource broker executes a device-specific, user-supplied script to pre-configure the server to be added to the appropriate load balancer, in systems where the servers are connected to load balancers. This may involve copying and installing tier specific applications or data on the server.

When the previous steps have completed successfully, the resource broker commands the provisioning function to execute the commands that add the server to the load balancer group (or directly to the network, if the load balancer is not employed). These commands may be sent directly to the load balancer device (or server) by means of a data access layer. As will be discussed further below, the data access layer provides the necessary command and protocol translation between the server and the MCI, controller, or device to be provisioned.

As is typical in network systems, any errors encountered in this process are sent to the client in the form of alerts and logged in a file.

When the resource broker is instructed to remove a server resource from a tier, it follows similar steps in reverse order. Firstly, the resource broker passes messages to the provisioning function to execute the commands to remove the server from the load balancer group (or the network). As above, these commands are sent directly to the load balancer or server device as may be required. At the conclusion of command execution the server is logically removed from the tier and unavailable to the customer group. Next, the resource broker executes a user-supplied script that cleans up the server and prepares it to be added back to the free pool. This script removes and uninstalls any tier-specific applications or data. Finally, the server is added to the appropriate free pool. Unless otherwise specified in the policy or rules, this is the free pool from which the resource was originally provisioned. Alternatively, the server may be directed to the global free pool or a particular customer's free pool. De-allocated servers may thus be logically removed from particular customer resource domains and applied to other customer resource domains by cross-allocating them to a global pool available to all customers.

As with provisioning, errors encountered in any of the above de-provisioning steps are sent to the client as alerts and logged in a file.

Provisioning Storage

As with provisioning server resources, storage provisioning must necessarily begin with a configuration step for the storage controllers/devices. Because of the wide variety of storage systems, NMSs and management schemes, this process is necessarily somewhat complex.

Initially, after the value added discovery step completes and the available resources are identified, cataloged, and classified into free pools, the storage pools are also organized into default resource pools representing logical unit numbers (LUNs) grouped by storage subsystem and RAID level. The file system storage may be displayed and grouped into private resource pools of LUNs already in use by the file system. In other words, for a given server, there may exist a file system A, which is comprised of LUN1, LUN2, LUN3, etc. There is also a second file system B which may consist of LUN4, LUN5, LUN6, etc. Storage pools, which are defined in this context to refer to groups of LUNs of the same type and under the same storage controller, are grouped together in the unallocated storage resource pool.

During configuration, the system manager must map the storage resources discovered and cataloged during value added discovery (VAD) into the free pool model. File systems will always move and be mapped with their servers and, logically, the LUNs from each file system must be moved and mapped with the file system.

File system VAD is performed though the use of conventional UNIX command line interfaces (CLIs), Logical Volume Manager CLIs, and local or remote Windows Manager interfaces (WMIs). This makes the File System resources the LUN or set of LUNs assigned (i.e. private pools, including the size of the available space existing on the set of LUNs in use by the file system) to it and the associated physical connection path.

Storage Subsystem VAD is preformed to build default pool of available LUNs that are visible to the storage hosts on that storage fabric. Storage configuration is done in the GUI to build public pools for storage hosts to draw from. Storage hosts are the assigned public pools from which to draw.

A provisioning request might not always need to go to the public free pool to get the resources it needs to extend a volume. If a file system is not consuming all of the storage capacity it already has allocated to it, then the file system will be expanded though a Logical Volume Manager to use that additional capacity.

If there is not enough space to satisfy the provisioning request within the private pool, then the public pool will yield at a minimum one full LUN resource to the file system's private pool, even if the request was for less than that. The provisioning request can specify whether or not to use the entire LUN at the time it is granted or consume it on an as-needed basis. The making available of LUN from the public pool is accomplished through use of LUN masking at the storage subsystem and the CLIs on the storage host.

The actual configuration of storage resources involves two major steps: (1) creation of free storage pools (either of default size or custom size); and (2) mapping of server file systems to draw additional storage from a single storage free pool. As unallocated storage resources are returned to free pools they create a storage free pool. At initial set up, the user may also choose to create a default storage free pool by defining one of the storage pools identified in the VAD process. Conceptually, the system manager may “move” (using the client GUI) a logical identifier of the particular storage pool into a “storage free pool” folder or container, thereby designating the storage resources in that pool as available to other file systems.

Alternatively, the system manager may create one or more custom free pools. Creating a custom free pool involves choosing a set of unassigned LUNs from a given unallocated storage pool and then “moving” them into the storage free pool folder. After the free pools are created, the LUNs that are in use by file systems are not displayed within the free pool. This is intuitively obvious, since allocated file systems necessarily require allocated resources and allocated resources are not free.

As the system manager iterates through the unassigned storage resources, he or she creates several storage free pools through the process identified above. The next major step is then to map the servers file systems to particular storage free pools, as selected by the system manager. This selection can be made through conventional means well-known in the art using the client GUI and simplified mappings of the candidate file systems and the various storage free pools, for example, in iconic form. Importantly, a file system may only draw storage resources from one storage free pool. Therefore, once a file system selection is made that file system cannot appear as a candidate for assignment to another storage free pool.

Stepping back to a higher level of abstraction, one can see that the fundamental task of storage provisioning, especially in a SAN, is to dynamically assign and de-assign the visibility of LUNs exported by the storage subsystem to and from servers connected to the network. This process is commonly called LUN masking. LUN masking, as is currently practiced, may be done with the storage subsystem controller management software or through a server. At this point, LUN control and configuration is readily performed through conventional means well-known in the art. It is important to remember that a storage free pool resource is essentially a collection of LUNs of the same type and often from the same vendor. Thus, there could be a pool of Raid-5 LUNs, a pool of mirrored LUNs, etc. A pool can contain LUNs from different storage subsystems, but all of the LUNs must be from the same vendor. This restriction may be, in some embodiments, enforced by the client GUI to meet the needs of certain customers; fundamentally, the present system is not so limited.

The major functions of storage provisioning fall into three categories: (1) extending existing file systems and creating new file systems on the servers; (2) extending raw storage capacity where file systems are not involved; and (3) deleting file systems.

The process of creating new file systems begins by locating qualified, but unallocated, LUNs within the storage free pools and assigning them through a server, creating a volume and building a file system. This process is executed through the provisioning module by means of commands and/or exercise of the API to the particular device controller handling the LUNs at issue. The actual steps in creating a file system are conventional in nature and well-known to those of ordinary skill in the art.

The process of extending an existing file system is somewhat distinct. First, the resource broker must identify free space on the LUNs already assigned to a particular server to see if it can accommodate the request. If the current LUN set does not accommodate the request, i.e., there is not sufficient storage space in the LUN set, the resource broker must look at the characteristics of the file system to determine which storage free pool can be selected to obtain additional, compatible LUNs. The resource broker then searches an appropriate storage free pool for a LUN or set of LUNs that meets the requirements of the extension request. Assuming a new LUN is necessary, the resource broker communicates with the provisioning function to execute the commands to add the LUN to the file system. These commands are sent directly from the provisioning function to the storage server, as well as the storage subsystem controller. As these commands are conventional commands of the type typically required and recognized by the storage subsystem controller and the server, their operation will not be discussed in further detail.

The resource broker can also increase raw storage capacity when there is no file system present. This functionality is applicable and useful to database servers that use raw table space. Firstly, the resource broker searches the storage pools to find unallocated space on qualified LUNs. Next, the LUNs are directly configured on the storage server. This increases the available raw volume capacity without invoking any file system activity. Configuration commands are sent directly to the server and the SAN controller device by conventional means.

De-provisioning storage systems results in a deletion of a file system. As this is a very destructive operation, extreme care must be taken. When the resource broker is instructed to delete a file system on a server it follows the following steps: first, the resource broker causes the provisioning function to execute the commands necessary to delete the file system. These commands are sent directly to the server as well as the storage subsystem controller and include deleting the volume on which the file system is built and de-assigning the LUNs at the storage subsystem controller. The LUNs that had originally formed the file system are returned to the storage free pool. Unless otherwise specified by policy, the LUNs are returned to the storage free pool from which they were originally provisioned. As discussed above, however, policy may dictate that the LUNs are returned to a default storage free pool or to a different public storage free pool.

Flow Chart

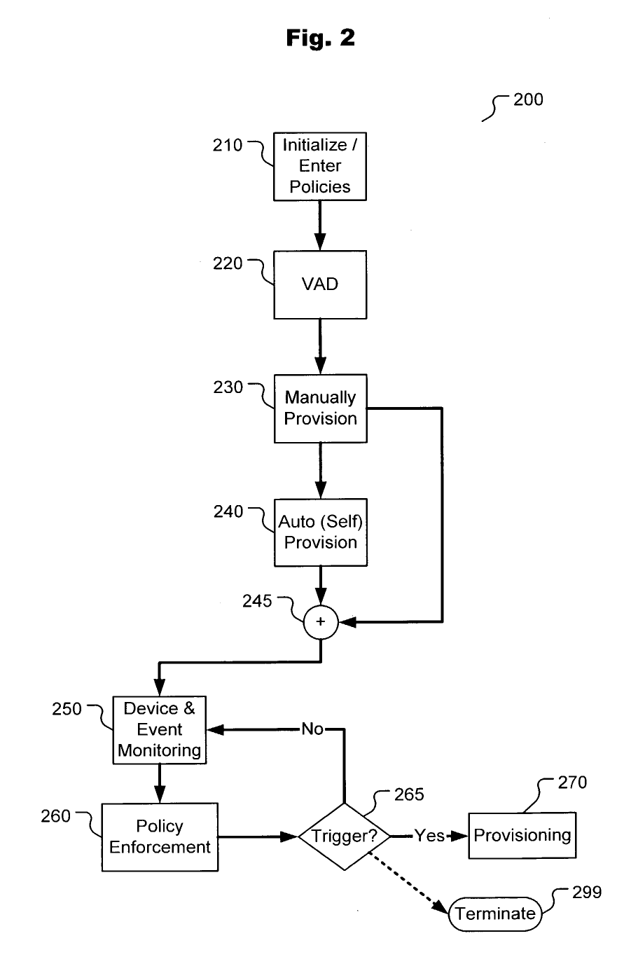

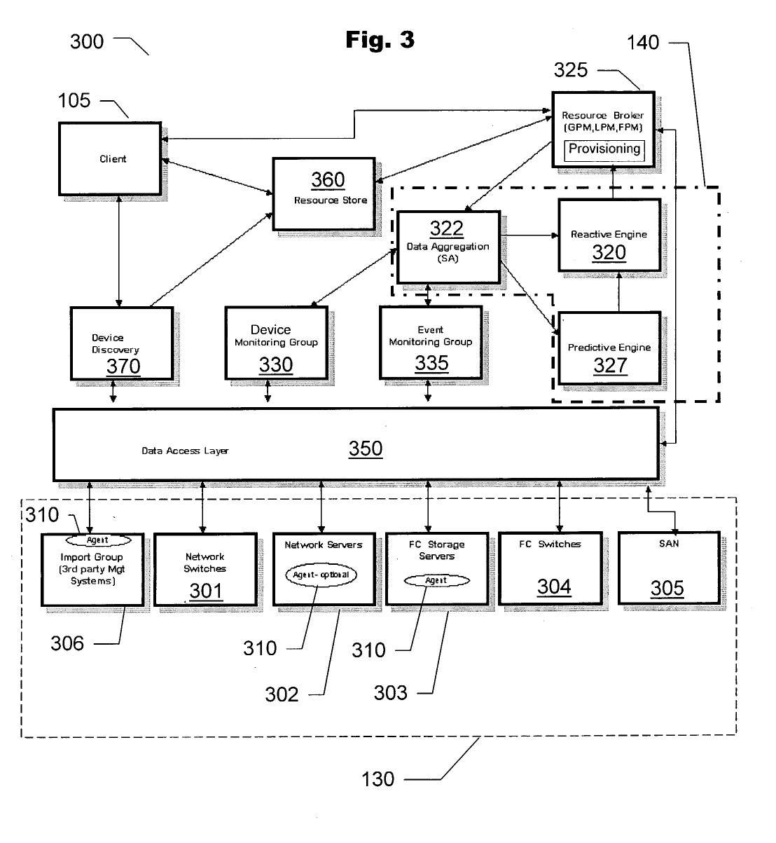

FIG. 2 describes a simplified flow chart of the initialization and operation of a dynamic network resource brokering method, according to one embodiment of the present invention. Process 200 begins with the initialization step 210, whereby the system manager inputs and the client application processes business policies and SLAs/SLOs. In step 220, the manager initiates value added discovery (VAD) to determine the resources on the network and their status. This function fills resource store 360 (see FIG. 3 below) with information and defines the free pools of both storage and server resources.

In step 230, the system manager may initialize manual provisioning of some or all of the servers or network resources. This step is optional; in some embodiments, the system may be commanded to automatically self-provision, step 240.

Step 240 applies business-policy derived rules to the network resources and configures the IT network infrastructure into an initial state that best satisfies all business policies.

At point 245, the system transitions from a configuration state to the brokering state and the resource broker begins the device and event monitoring process, step 250. As data is obtained and aggregated in device and event monitoring process 250, the policy enforcement function 260 acts on that data to provide the comparison of aggregated data with rule conditions. Policy enforcement step 260 thus provides triggering events to the resource broker. This triggering event is represented by step 265 wherein if a rule condition is met then a provisioning or de-provisioning action is triggered, represented by the “yes” branch and provisioning step 270. If there is no policy enforcement trigger, then the process loops to device and event monitor step 250. Likewise, at the conclusion of provisioning step 270 the process returns to monitoring step 250.

The brokering state represented by steps 250-270 continues until the system is commanded out of the brokering state or until system failure. Such events, although not shown in FIG. 2, are conceptually part of the triggering test 265, whereby the appropriate event or command will cause the system to terminate. This is represented by the dashed path and termination block 299.

Regarding device and event monitoring step 250, which also may be referred to as a status detecting step, in some embodiments of the present invention this process operates nearly continuously, in an approximately real time fashion. In an alternate embodiment, however, this process may operate according to a timer, such as a well-known watchdog time, which causes the monitoring process to trigger after a predefined interval of time, such as every five seconds or every minute. One of ordinary skill in the art will appreciate that a multitude of monitoring schemes are possible for the network resources discussed here. Accordingly, the present invention is not limited to a particular type of monitoring, nor is it limited to a particular monitoring timing or repeat interval.

Module Functional Block Diagram

FIG. 3 illustrates a functional block diagram of the system in high-level form. Here, system 300 includes client 105, data access layer 350 and resource group 130. Client 105, as described above with reference to FIG. 1, consists of the client application and its GUI. Resource group 130 may consist, for example, of one or more different types of commonly networked resources, such as network switches 301, network servers 302, Fibre Channel storage servers 303, Fibre Channel switches 304, storage area networks 305 and MCIs or third party management systems 306.

Some or all of these resources may employ agents 310 as interfaces to data access layer 350. As the term is commonly used in the art, “agent” refers to a software module, process, or thread that provides an active interface function with a certain level of autonomy between two or more modules, processes, or threads. In this instance, agent 310 may provide an interface between data access layer 350 and one or more of network resources in resource group 130.

Data access layer 350 is the command translation layer that interfaces between the provisioning function of resource broker 325 and the members of resource group 130. Data access layer 350 provides both the physical and logical protocol conversion of commands from the resource broker to the device specific commands and APIs required or used by the various network resources 301 through 306 and/or agents 310.

Policy enforcement function of 140 may be, in some embodiments, implemented by means of two engines. Reactive engine 320 processes and monitors data from data aggregation function 322 and determines provisioning responses for the resource broker/provisioning function 325. Alternatively, and sometimes concurrently, predictive engine 325 utilizes historical data (from data aggregation function 322) to trigger reactive engine 320 into an early initiation of provisioning functions.

Data aggregation function 322 obtains its information from device monitoring group 330 and event monitoring group 335. As their names imply these processes or threads 330 and 335 monitor both the devices in the resource group 130. This monitoring provides both the historical data needed by predictive engine 325 as well as the real-time status data needed for display by client 105.

Resource store 360 may be a logical table or other data structure that contains the identifiers making up the various free pools and allocated resource information in the various tiers, solutions, and customers. This may be thought of as the database or data store for the state and dynamic variables of the server application.

Device discovery function 370 performs value added discovery (VAD) upon command from client application 105. As discussed above, value added discovery is the initial intelligence functionality of the server application. Value added discovery queries the various resources 301-306 in resource pool 130 to determine their individual status, configuration, type and capabilities. Device discovery 370 may make use of external configuration files or tables, not shown, to formulate a complete picture of the resources available for provisioning in the system. Device discovery 370 conveys its information to resource store 360 and to client 105.

As discussed above, in operation client 105 initially commands device discovery 370 to determine to perform value added discovery and determine the state and configuration of all network resources. Device discovery 370 passes commands through data access layer 350 and thus “talks” directly to all of the network resources 130. Once value added discovery is completed, resource store 360 is fully populated with descriptive information on all resources and has assigned all of those resources to free pools determined by the policy requirements set in client 105. At this point, system 300 may be commanded to leave the configuration state and enter the brokering state, wherein resource broker 325 takes over control and automates the brokering and provisioning process.

As described above, resource broker 325 may employ reactive and predictive engines 320 and 325, respectively, to sense the state of network resources 130 (via data aggregation information 322 and resource store 360) in order to enforce business policies representing SLAs and SLOs on the network. Device monitoring group 330 and event monitoring group 335 are the “eyes and ears” of the system, determining system status and configuration of the operational (brokering state) system and passing that information to data aggregation unit 322. Through the use of the monitoring groups and the data aggregation function, policy enforcement engine 140 is thus able to determine when resource allocation and deallocation is necessary. Passing that information to resource broker 325 by means of standard interprocess communication techniques, the system is thus able to then identify resources that are affected and provision them accordingly.

Value added discovery consumes bare bones, user-supplied device descriptions though the import of a comma-separated value (CSV) file. The value added discovery process quantifies these physical devices though the use of various data access methods that allow the policy enforcement part of the product to make intelligent decisions for allocating these resources when provisioning or de-provisioning is required.

Service levels may also be described as in conventional usage, e.g., Gold, Silver, or Bronze, denoting more or less capability, responsiveness, or quality guarantee. The system may enforce resource provisioning request servicing within the server, where requests are expressed in terms of service level. Thus, for example, Gold requests may be serviced first, therefore drawing from the public free pool on a priority basis.

Alternate Embodiments

The order in which the steps of the present method are performed is purely illustrative in nature. In fact, the steps can be performed in any order or in parallel, unless otherwise indicated by the present disclosure.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to an internet or intranet. Accordingly, the present invention is not limited to any particular platform, unless specifically stated otherwise in the present disclosure.

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

We claim:

1. A method of brokering network resources, comprising:
interpreting one or more policies into one or more rules;
detecting a first resource configuration;
modifying said first resource configuration into a second resource configuration by
monitoring the status of said resource configuration;
comparing said status to one or more of said rules;
automatically provisioning said first resource configuration into said second resource configuration in response to said comparing; and
periodically updating said modifying based on repeating said detecting said first resource configuration.

2. The method of claim 1, wherein said periodically detecting further comprises predicting a future status.

3. The method of claim 1, wherein said policies define differentiated levels of service.

4. The method of claim 1, wherein said detecting further comprises discovering an initial resource configuration.

5. The method of claim 1, wherein said resource configuration comprises one or more servers and zero or more memory elements.

6. An apparatus for brokering network resources, comprising:
means for interpreting one or more policies into one or more rules;
means for detecting a first resource configuration;
means for modifying said first resource configuration into a second resource configuration by
monitoring the status of said resource configuration;
comparing said status to one or more of said rules;
automatically provisioning said first resource configuration into said second resource configuration in response to said comparing; and
means for periodically updating said modifying based on repeating said detecting said first resource configuration.

7. The apparatus of claim 6, wherein said means for detecting further comprise means for predicting a future status.

8. The apparatus of claim 6, wherein said policies define differentiated levels of service.

9. The apparatus of claim 6, wherein said means for detecting further comprise means for discovering an initial resource configuration.

10. The apparatus of claim 6, wherein said resource configuration comprises one or more servers and zero or more memory elements.

11. A computer system for use in brokering network resources, comprising computer instructions for:
interpreting one or more policies into one or more rules;
detecting a first resource configuration;
modifying said first resource configuration into a second resource configuration by
monitoring the status of said resource configuration;
comparing said status to one or more of said rules;
automatically provisioning said first resource configuration into said second resource configuration in response to said comparing; and
periodically updating said modifying based on repeating said detecting said first resource configuration.

12. The computer system of claim 11, wherein said detecting further comprises predicting a future status.

13. The computer system of claim 11, wherein said policies define differentiated levels of service.

14. The computer system of claim 11, wherein said detecting further comprises discovering an initial resource configuration.

15. The computer system of claim 11, wherein said resource configuration comprises one or more servers and zero or more memory elements.

16. A computer-readable medium storing a computer program executable by a plurality of server computers, the computer program comprising computer instructions for:
interpreting one or more policies into one or more rules;
detecting a first resource configuration;
modifying said first resource configuration into a second resource configuration by
monitoring the status of said resource configuration;
comparing said status to one or more of said rules;
automatically provisioning said first resource configuration into said second resource configuration in response to said comparing; and
periodically updating said modifying based on repeating said detecting said first resource configuration.

17. The computer-readable medium of claim 16, wherein said detecting further comprises predicting a future status.

18. The computer-readable medium of claim 16, wherein said policies define differentiated levels of service.

19. The computer-readable medium of claim 16, wherein said detecting further comprises discovering an initial resource configuration.

20. The computer-readable medium of claim 16, wherein said resource configuration comprises one or more servers and zero or more memory elements.

21. A computer data signal embodied in a carrier wave, comprising computer instructions for:
interpreting one or more policies into one or more rules;
detecting a first resource configuration;
modifying said first resource configuration into a second resource configuration by
monitoring the status of said resource configuration;
comparing said status to one or more of said rules;
automatically provisioning said first resource configuration into said second resource configuration in response to said comparing; and
periodically updating said modifying based on repeating said detecting said first resource configuration.

22. The computer data signal of claim 21, wherein said detecting further comprises predicting a future status.

23. The computer data signal of claim 21, wherein said policies define differentiated levels of service.

24. The computer data signal of claim 21, wherein said detecting further comprises discovering an initial resource configuration.

25. The computer data signal of claim 21, wherein said resource configuration comprises one or more servers and zero or more memory elements.
